(19) United States
(12) Patent Application Publication
(10) Pub. No.: US 2023/0292173 A1
(43) Pub. Date: Sep. 14, 2023

(54) AUTONOMOUS ACTIVATION OF A FEATURE AT A WIRELESS COMMUNICATION DEVICE TO MEET SURVIVAL TIME OF AN APPLICATION CONSUMING A COMMUNICATION SERVICE

(71) Applicant: Telefonaktiebolaget LM Ericsson (publ), Stockholm (SE)

(72) Inventors: Zhenhua Zou, Solna (SE); Torsten Dudda, Wassenberg (DE)

(21) Appl. No.: 18/019,503

(22) PCT Filed: Aug. 4, 2021
(86) PCT No.: PCT/IB2021/057169

§ 371 Date: Feb. 3, 2023

Related U.S. Application Data
(60) Provisional application No. 63/062,020, filed on Aug. 6, 2020.

(51) Int. Cl. H04W 28/06

(52) U.S. Cl. CPC H04W 28/06

(57) ABSTRACT

Systems and methods are disclosed herein for autonomous activation of a feature at a wireless communication device to meet survival time of an application consuming a communication service. In one embodiment, a method performed by a wireless communication device comprises obtaining a timer related to survival time, the survival time being an amount of time that an application consuming a communication service may continue without an anticipated message. The method further comprises autonomously activating a feature based on the timer, the feature being Packet Data Convergence Protocol (PDCP) packet duplication, one or more additional PDCP packet duplication legs in a case where PDCP packet duplication is already activated, or another mechanism that increases reliability of packet transmission.

### RELATED APPLICATIONS

This application claims the benefit of provisional patent application Ser. No. 63/062,020, filed Aug. 6, 2020, the disclosure of which is hereby incorporated herein by reference in its entirety.

### TECHNICAL FIELD

The present disclosure relates to a cellular communications system and, more specifically, to autonomous activation of a feature at a wireless communication device to ensure that a survival time of an application consuming a communication service is met.

### BACKGROUND

Packet duplication is a feature that is defined for Fifth Generation (5G) New Radio (NR) in order to enhance throughput and reliability of the NR radio access network. Third Generation Partnership Project (3GPP) Technical Specification (TS) 38.300 v16.2, Section 16.1.3 describes packet duplication.

Packet duplication is done at the Packet Data Convergence Protocol (PDCP) layer, where original and duplicate Protocol Data Units (PDUs) are provided to multiple lower layer Radio Link Control (RLC) entities for transmission via different carriers. This is possible in Dual Connectivity (DC) and Carrier Aggregation (CA) protocol architectures. Both Radio Resource Control (RRC) signaling and Medium Access Control (MAC) Control Elements (CEs) can be used to control activation/deactivation of packet duplication in the User Equipment (UE) in uplink (UL) by the NR base station (gNB). The PDCP entity including packet duplication is configured per radio bearer, e.g. per data radio bearer (DRB).

In the 5G Quality of Service (QoS) framework, a QoS flow is established in the 5G system and can be mapped to a DRB. The QoS flow is associated with QoS parameters, such as Packet Delay Budget (PDB), which are associated to a 5G QoS Identifier (5QI). The 5G Radio Access Network (RAN) scheduling packets of this QoS flow (mapped to a DRB in 5G RAN) shall thus deliver packets in accordance with the associated QoS parameters (e.g., within the associated PDB).

Another metric discussed in the industrial automation communication context, related to PDB, is the so called “survival time.” According to 3GPP TS 22.104 v17.3, the “survival time” is defined as the time that an application consuming a communication service may continue without an anticipated message. The message is anticipated at the end of the PDB, and the survival time is the maximum additional time that a message is expected after PDB.

For Time Sensitive Communication (TSC) traffic types (e.g., TSC traffic types that are typical in industrial automation communication), 3GPP TS 23.501 v16.5.0 specifies TSC Assistance Information (TSCAI) signaling, with which further information on the QoS flow traffic can be provided from the 5G core network to the RAN. This signaling currently includes information on UL/downlink (DL) direction, periodicity, and arrival time of a burst of data in this flow.

It is up to current discussions in 3GPP (as part of Rel-17 work item RP-201310) whether survival time should also be signaled to the RAN (e.g., as part of TSCAI) and how the RAN can make use of this metric.

It is currently unclear how the RAN can make use of the survival time metric to ensure it is met in an efficient way. It is in particular not clear how a UE should be configured and/or consider the survival time metric itself.

### SUMMARY

Systems and methods are disclosed herein for autonomous activation of a feature at a wireless communication device to meet survival time of an application consuming a communication service. In one embodiment, a method performed by a wireless communication device comprises obtaining a timer related to survival time, the survival time being an amount of time that an application consuming a communication service may continue without an anticipated message. The method further comprises autonomously activating a feature based on the timer, the feature being Packet Data Convergence Protocol (PDCP) packet duplication, one or more additional PDCP packet duplication legs in a case where PDCP packet duplication is already activated, or another mechanism that increases reliability of packet transmission. In this manner, spectral efficiency may be provided by the wireless communication device autonomously triggering high reliability transmissions, e.g., only when necessary to meet the survival time requirement, instead of always transmitting with high reliability. Furthermore, the extra reliability provided by the autonomous activation of the feature by the wireless communication device allows applications (e.g., industrial applications) to work with higher availability.

In one embodiment, the timer is a PDCP discard timer, and autonomously activating the feature based on the timer comprises autonomously activating (406) the feature comprises autonomously activating the feature upon discarding a packet upon expiry of the PDCP timer.

In one embodiment, the timer is a timer that is specific for the purpose of activating the feature, and autonomously activating the feature based on the timer comprises autonomously activating the feature upon expiry of the timer.

In one embodiment, a PDCP packet duplication leg is a Radio Link Control (RLC) entity to which PDCP duplication is activated.

In one embodiment, the method further comprises transmitting one or more packets using the activated feature.

In one embodiment, autonomously activating the feature comprises autonomously activating PDCP packet duplication or one or more additional PDCP packet duplication legs. In one embodiment, autonomously activating PDCP packet duplication or one or more additional PDCP packet duplication legs comprises autonomously activating all configured but currently inactive PDCP packet duplication legs. In another embodiment, autonomously activating PDCP packet duplication or one or more additional PDCP packet duplication legs comprises autonomously activating a subset of all configured but currently inactive PDCP packet duplication legs. In one embodiment, the subset of all configured but currently inactivate PDCP packet duplication legs comprises one or more PDCP packet duplication legs associated to one or more cell groups other than a cell group to which an existing, activated RLC entity belongs. In another embodiment, autonomously activating PDCP packet duplication or one or more additional PDCP packet duplication legs comprises successively activating one or more additional PDCP packet duplication legs.

In one embodiment, autonomously activating PDCP packet duplication or one or more additional PDCP packet duplication legs comprises autonomously activating PDCP packet duplication or one or more additional PDCP packet duplication legs based on priorities associated to PDCP packet duplication legs.

In one embodiment, autonomously activating PDCP packet duplication or one or more additional PDCP packet duplication legs comprises autonomously activating PDCP packet duplication or one or more additional PDCP packet duplication legs based on a predefined or configured number of PDCP packet duplication legs to be activated.

In one embodiment, autonomously activating PDCP packet duplication or one or more additional PDCP packet duplication legs comprises autonomously activating PDCP packet duplication using a PDCP packet duplication leg that is a fallback for split radio bearer operation.

In one embodiment, the method further comprises deactivating the activated feature. In one embodiment, deactivating the activated feature comprises deactivating the activated feature in response to signaling from a network node. In another embodiment, deactivating the activated feature comprises deactivating the activated feature responsive to expiry of a timer.

Corresponding embodiments of a wireless communication device are also disclosed. In one embodiment, a wireless communication device is adapted to obtain a timer related to survival time, the survival time being an amount of time that an application consuming a communication service may continue without an anticipated message. The wireless communication device is further adapted to autonomously activate a feature based on the timer, the feature being PDCP packet duplication, one or more additional PDCP packet duplication legs in a case where PDCP packet duplication is already activated, or another mechanism that increases reliability of packet transmission.

In one embodiment, a wireless communication device comprises one or more transmitters, one or more receivers, and processing circuitry associated with the one or more transmitters and the one or more receivers. The processing circuitry is configured to cause the wireless communication device to obtain a timer related to survival time, the survival time being an amount of time that an application consuming a communication service may continue without an anticipated message. The processing circuitry is further configured to cause the wireless communication device to autonomously activate a feature based on the timer, the feature being PDCP packet duplication, one or more additional PDCP packet duplication legs in a case where PDCP packet duplication is already activated, or another mechanism that increases reliability of packet transmission.

Embodiments of a method performed by a base station are also disclosed. In one embodiment, a method performed by a base station comprises providing a timer related to survival time to a wireless communication device, the survival time being an amount of time that an application consuming a communication service may continue without an anticipated message. The method further comprises providing, to the wireless communication device, one or more parameters related to autonomous activation of a feature at the wireless communication device, the feature being PDCP packet duplication, one or more additional PDCP packet duplication legs in a case where PDCP packet duplication is already activated, or some other mechanism that increases reliability of packet transmission.

In one embodiment, a PDCP packet duplication leg is a RLC entity to which PDCP duplication is activated.

In one embodiment, the one or more parameters comprise information that identifies one or more PDCP packet duplication legs to be prioritized by the wireless communication device for autonomous PDCP activation or autonomous activation of one or more additional PDCP packet duplication legs.

In one embodiment, the one or more parameters comprise information that indicates a number of PDCP packet duplication legs that can be activated by the wireless communication device for autonomous PDCP activation or autonomous activation of one or more additional PDCP packet duplication legs.

Corresponding embodiments of a base station are also disclosed. In one embodiment, a base station is adapted to provide a timer related to survival time to a wireless communication device, the survival time being an amount of time that an application consuming a communication service may continue without an anticipated message. The base station is further adapted to provide, to the wireless communication device, one or more parameters related to autonomous activation of a feature at the wireless communication device, the feature being PDCP packet duplication, one or more additional PDCP packet duplication legs in a case where PDCP packet duplication is already activated, or some other mechanism that increases reliability of packet transmission.

In one embodiment, a base station comprises processing circuitry configured to cause the base station to provide a timer related to survival time to a wireless communication device, the survival time being an amount of time that an application consuming a communication service may continue without an anticipated message. The base station is further adapted to provide, to the wireless communication device, one or more parameters related to autonomous activation of a feature at the wireless communication device, the feature being PDCP packet duplication, one or more additional PDCP packet duplication legs in a case where PDCP packet duplication is already activated, or some other mechanism that increases reliability of packet transmission.

### BRIEF DESCRIPTION OF THE DRAWINGS

The accompanying drawing figures incorporated in and forming a part of this specification illustrate several aspects of the disclosure, and together with the description serve to explain the principles of the disclosure.

FIG. 1 illustrates one example of a cellular communications system in which embodiments of the present disclosure may be implemented;

FIGS. 2 and 3 illustrate different representations of one example of the cellular communications system of FIG. 1 in which the cellular communications system is a Third Generation Partnership Project (3GPP) Fifth Generation (5G) system;

FIG. 4 illustrates the operation of a wireless communication device (e.g., a User Equipment (UE)) and a base station in accordance with at least some of the embodiments described herein;

FIGS. 5 through 7 are schematic block diagrams of example embodiments of a radio access node in which embodiments of the present disclosure may be implemented;

FIGS. 8 and 9 are schematic block diagrams of example embodiments of a wireless communication device;

FIG. 10 illustrates an example embodiment of a communication system in which embodiments of the present disclosure may be implemented;

FIG. 11 illustrates example embodiments of the host computer, base station, and UE of FIG. 10; and

FIGS. 12 through 15 are flow charts that illustrate example embodiments of methods implemented in a communication system such as that of FIG. 10.

### DETAILED DESCRIPTION

The embodiments set forth below represent information to enable those skilled in the art to practice the embodiments and illustrate the best mode of practicing the embodiments. Upon reading the following description in light of the accompanying drawing figures, those skilled in the art will understand the concepts of the disclosure and will recognize applications of these concepts not particularly addressed herein. It should be understood that these concepts and applications fall within the scope of the disclosure.

Some of the embodiments contemplated herein will now be described more fully with reference to the accompanying drawings. Other embodiments, however, are contained within the scope of the subject matter disclosed herein, the disclosed subject matter should not be construed as limited to only the embodiments set forth herein; rather, these embodiments are provided by way of example to convey the scope of the subject matter to those skilled in the art.

Generally, all terms used herein are to be interpreted according to their ordinary meaning in the relevant technical field, unless a different meaning is clearly given and/or is implied from the context in which it is used. All references to a/an/the element, apparatus, component, means, step, etc. are to be interpreted openly as referring to at least one instance of the element, apparatus, component, means, step, etc., unless explicitly stated otherwise. The steps of any methods disclosed herein do not have to be performed in the exact order disclosed, unless a step is explicitly described as following or preceding another step and/or where it is implicit that a step must follow or precede another step. Any feature of any of the embodiments disclosed herein may be applied to any other embodiment, wherever appropriate. Likewise, any advantage of any of the embodiments may apply to any other embodiments, and vice versa. Other objectives, features, and advantages of the enclosed embodiments will be apparent from the following description.

Radio Node: As used herein, a “radio node” is either a radio access node or a wireless communication device.

Radio Access Node: As used herein, a “radio access node” or “radio network node” or “radio access network node” is any node in a Radio Access Network (RAN) of a cellular communications network that operates to wirelessly transmit and/or receive signals. Some examples of a radio access node include, but are not limited to, a base station (e.g., a New Radio (NR) base station (gNB) in a Third Generation Partnership Project (3GPP) Fifth Generation (5G) NR network or an enhanced or evolved Node B (eNB) in a 3GPP Long Term Evolution (LTE) network), a high-power or macro base station, a low-power base station (e.g., a micro base station, a pico base station, a home eNB, or the like), a relay node, a network node that implements part of the functionality of a base station (e.g., a network node that implements a gNB Central Unit (gNB-CU) or a network node that implements a gNB Distributed Unit (gNB-DU)) or a network node that implements part of the functionality of some other type of radio access node.

Core Network Node: As used herein, a “core network node” is any type of node in a core network or any node that implements a core network function. Some examples of a core network node include, e.g., a Mobility Management Entity (MME), a Packet Data Network Gateway (P-GW), a Service Capability Exposure Function (SCEF), a Home Subscriber Server (HSS), or the like. Some other examples of a core network node include a node implementing an Access and Mobility Management Function (AMF), a User Plane Function (UPF), a Session Management Function (SMF), an Authentication Server Function (AUSF), a Network Slice Selection Function (NSSF), a Network Exposure Function (NEF), a Network Function (NF) Repository Function (NRF), a Policy Control Function (PCF), a Unified Data Management (UDM), or the like.

Communication Device: As used herein, a “communication device” is any type of device that has access to an access network. Some examples of a communication device include, but are not limited to: mobile phone, smart phone, sensor device, meter, vehicle, household appliance, medical appliance, media player, camera, or any type of consumer electronic, for instance, but not limited to, a television, radio, lighting arrangement, tablet computer, laptop, or Personal Computer (PC). The communication device may be a portable, hand-held, computer-comprised, or vehicle-mounted mobile device, enabled to communicate voice and/or data via a wireless or wireline connection.

Wireless Communication Device: One type of communication device is a wireless communication device, which may be any type of wireless device that has access to (i.e., is served by) a wireless network (e.g., a cellular network). Some examples of a wireless communication device include, but are not limited to: a User Equipment device (UE) in a 3GPP network, a Machine Type Communication (MTC) device, and an Internet of Things (IoT) device. Such wireless communication devices may be, or may be integrated into, a mobile phone, smart phone, sensor device, meter, vehicle, household appliance, medical appliance, media player, camera, or any type of consumer electronic, for instance, but not limited to, a television, radio, lighting arrangement, tablet computer, laptop, or PC. The wireless communication device may be a portable, hand-held, computer-comprised, or vehicle-mounted mobile device, enabled to communicate voice and/or data via a wireless connection.

Network Node: As used herein, a “network node” is any node that is either part of the RAN or the core network of a cellular communications network/system.

Note that the description given herein focuses on a 3GPP cellular communications system and, as such, 3GPP terminology or terminology similar to 3GPP terminology is oftentimes used. However, the concepts disclosed herein are not limited to a 3GPP system.

PDCP Packet Duplication Leg: As used herein, a “PDCP packet duplication leg” or similar term refers to a separate carrier or cell, or more specifically a Radio Link Control (RLC) entity, that may be activated for a wireless communication device (e.g., a UE) for, e.g., carrier aggregation or multi-connectivity (e.g., dual-connectivity).

Note that, in the description herein, reference may be made to the term “cell”; however, particularly with respect to 5G NR concepts, beams may be used instead of cells and, as such, it is important to note that the concepts described herein are equally applicable to both cells and beams.

There currently exist certain challenge(s). As discussed above, it is currently unclear how the 5G RAN (also referred to herein as the Next Generation RAN (NG-RAN)) can make use of the survival time metric to ensure it is met in an efficient way. It is in particular not clear how a UE should be configured and/or consider the survival time metric itself.

Certain aspects of the present disclosure and their embodiments may provide solutions to the aforementioned or other challenges. Embodiments of a method in a UE to meet the requirement of the survival time by the UE triggering high-reliability transmissions when approaching the indicated survival time are disclosed herein. In a particular embodiment, a UE triggers Packet Date Convergence Protocol (PDCP) packet duplication transmissions for subsequent packet transmissions when a PDCP packet is discarded based on PDCP discard timer.

Certain embodiments may provide one or more of the following technical advantage(s). Embodiments of the solution described herein may increase spectral efficiency by the UE adaptively triggering high reliability transmissions only when necessary to meet the survival time requirement, instead of always transmitting with high reliability. Furthermore, the extra reliability triggered by the UE thus meeting the survival time metric allows applications (e.g., industrial applications) to work with higher availability.

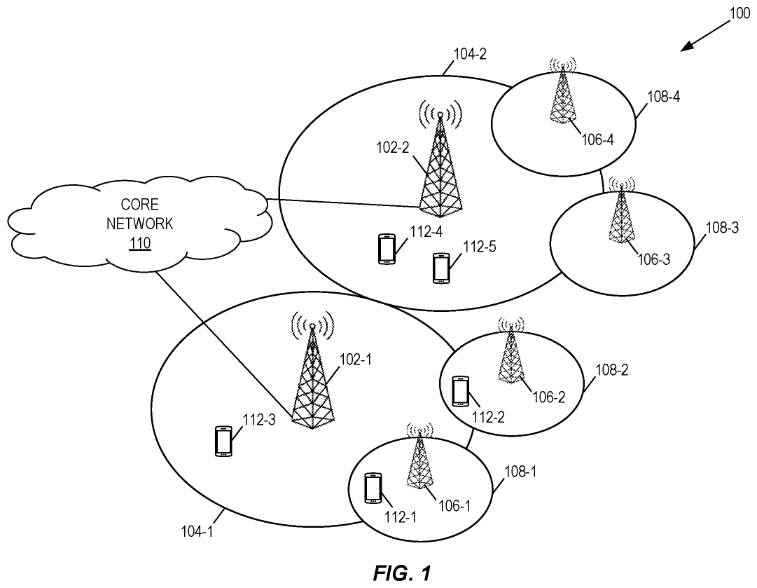

FIG. 1 illustrates one example of a cellular communications system 100 in which embodiments of the present disclosure may be implemented. In the embodiments described herein, the cellular communications system 100 is a 5G system (5GS) including a Next Generation RAN (NG-RAN) and a 5G Core (5GC); however, the solution described herein is not limited thereto. In this example, the RAN includes base stations 102-1 and 102-2, which in the 5GS include NR base stations (gNBs) and optionally next generation eNBs (ng-eNBs) (e.g., LTE RAN nodes connected to the 5GC), controlling corresponding (macro) cells 104-1 and 104-2. The base stations 102-1 and 102-2 are generally referred to herein collectively as base stations 102 and individually as base station 102. Likewise, the (macro) cells 104-1 and 104-2 are generally referred to herein collectively as (macro) cells 104 and individually as (macro) cell 104. The RAN may also include a number of low power nodes 106-1 through 106-4 controlling corresponding small cells 108-1 through 108-4. The low power nodes 106-1 through 106-4 can be small base stations (such as pico or femto base stations) or Remote Radio Heads (RRHs), or the like. Notably, while not illustrated, one or more of the small cells 108-1 through 108-4 may alternatively be provided by the base stations 102. The low power nodes 106-1 through 106-4 are generally referred to herein collectively as low power nodes 106 and individually as low power node 106. Likewise, the small cells 108-1 through 108-4 are generally referred to herein collectively as small cells 108 and individually as small cell 108. The cellular communications system 100 also includes a core network 110, which in the 5GS is the 5GC. The base stations 102 (and optionally the low power nodes 106) are connected to the core network 110.

The base stations 102 and the low power nodes 106 provide service to wireless communication devices 112-1 through 112-5 in the corresponding cells 104 and 108. The wireless communication devices 112-1 through 112-5 are generally referred to herein collectively as wireless communication devices 112 and individually as wireless communication device 112. In the following description, the wireless communication devices 112 are oftentimes UEs and as such sometimes referred to herein as UEs 112, but the present disclosure is not limited thereto.

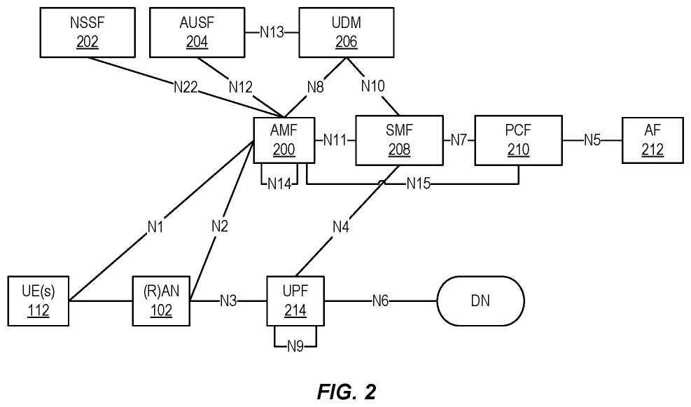

FIG. 2 illustrates a wireless communication system represented as a 5G network architecture composed of core Network Functions (NFs), where interaction between any two NFs is represented by a point-to-point reference point/interface. FIG. 2 can be viewed as one particular implementation of the system 100 of FIG. 1.

Seen from the access side the 5G network architecture shown in FIG. 2 comprises a plurality of UEs 112 connected to either a RAN 102 or an Access Network (AN) as well as an AMF 200. Typically, the R(AN) 102 comprises base stations, e.g. such as eNBs or gNBs or similar. Seen from the core network side, the 5GC NFs shown in FIG. 2 include a NSSF 202, an AUSF 204, a UDM 206, the AMF 200, a SMF 208, a PCF 210, and an Application Function (AF) 212.

Reference point representations of the 5G network architecture are used to develop detailed call flows in the normative standardization. The N1 reference point is defined to carry signaling between the UE 112 and AMF 200. The reference points for connecting between the AN 102 and AMF 200 and between the AN 102 and UPF 214 are defined as N2 and N3, respectively. There is a reference point, N11, between the AMF 200 and SMF 208, which implies that the SMF 208 is at least partly controlled by the AMF 200. N4 is used by the SMF 208 and UPF 214 so that the UPF 214 can be set using the control signal generated by the SMF 208, and the UPF 214 can report its state to the SMF 208. N9 is the reference point for the connection between different UPFs 214, and N14 is the reference point connecting between different AMFs 200, respectively. N15 and N7 are defined since the PCF 210 applies policy to the AMF 200 and SMF 208, respectively. N12 is required for the AMF 200 to perform authentication of the UE 112. N8 and N10 are defined because the subscription data of the UE 112 is required for the AMF 200 and SMF 208.

The 5GC network aims at separating UP and CP. The UP carries user traffic while the CP carries signaling in the network. In FIG. 2, the UPF 214 is in the UP and all other NFs, i.e., the AMF 200, SMF 208, PCF 210, AF 212, NSSF 202, AUSF 204, and UDM 206, are in the CP. Separating the UP and CP guarantees each plane resource to be scaled independently. It also allows UPFs to be deployed separately from CP functions in a distributed fashion. In this architecture, UPFs may be deployed very close to UEs to shorten the Round Trip Time (RTT) between UEs and data network for some applications requiring low latency.

The core 5G network architecture is composed of modularized functions. For example, the AMF 200 and SMF 208 are independent functions in the CP. Separated AMF 200 and SMF 208 allow independent evolution and scaling. Other CP functions like the PCF 210 and AUSF 204 can be separated as shown in FIG. 2. Modularized function design enables the 5GC network to support various services flexibly.

Each NF interacts with another NF directly. It is possible to use intermediate functions to route messages from one NF to another NF. In the CP, a set of interactions between two NFs is defined as service so that its reuse is possible. This service enables support for modularity. The UP supports interactions such as forwarding operations between different UPFs.

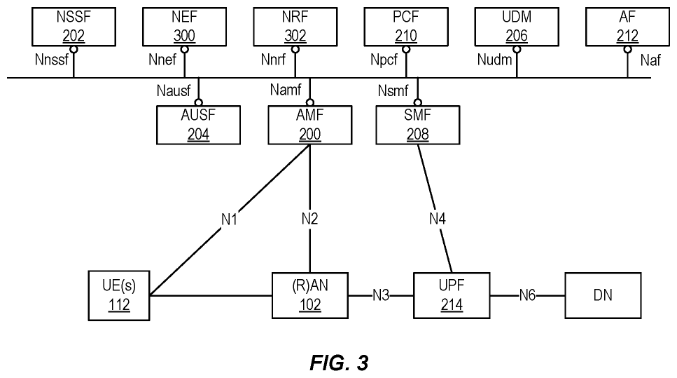

FIG. 3 illustrates a 5G network architecture using service-based interfaces between the NFs in the CP, instead of the point-to-point reference points/interfaces used in the 5G network architecture of FIG. 2. However, the NFs described above with reference to FIG. 2 correspond to the NFs shown in FIG. 3. The service(s) etc. that a NF provides to other authorized NFs can be exposed to the authorized NFs through the service-based interface. In FIG. 3 the service based interfaces are indicated by the letter “N” followed by the name of the NF, e.g. Namf for the service based interface of the AMF 200 and Nsmf for the service based interface of the SMF 208, etc. The NEF 300 and the NRF 302 in FIG. 3 are not shown in FIG. 2 discussed above. However, it should be clarified that all NFs depicted in FIG. 2 can interact with the NEF 300 and the NRF 302 of FIG. 3 as necessary, though not explicitly indicated in FIG. 2.

Some properties of the NFs shown in FIGS. 2 and 3 may be described in the following manner. The AMF 200 provides UE-based authentication, authorization, mobility management, etc. A UE 112 even using multiple access technologies is basically connected to a single AMF 200 because the AMF 200 is independent of the access technologies. The SMF 208 is responsible for session management and allocates Internet Protocol (IP) addresses to UEs. It also selects and controls the UPF 214 for data transfer. If a UE 112 has multiple sessions, different SMFs 208 may be allocated to each session to manage them individually and possibly provide different functionalities per session. The AF 212 provides information on the packet flow to the PCF 210 responsible for policy control in order to support QoS. Based on the information, the PCF 210 determines policies about mobility and session management to make the AMF 200 and SMF 208 operate property. The AUSF 204 supports authentication function for UEs or similar and thus stores data for authentication of UEs or similar while the UDM 206 stores subscription data of the UE 112. The Data Network (DN), not part of the 5GC network, provides Internet access or operator services and similar.

An NF may be implemented either as a network element on a dedicated hardware, as a software instance running on a dedicated hardware, or as a virtualized function instantiated on an appropriate platform, e.g., a cloud infrastructure.

Now, a description of some particular embodiments of the present disclosure will now be provided. According to some embodiments of the present disclosure, the UE 112 autonomously activates PDCP duplication transmissions based on a bigger of PDCP discard timer expiry. This is useful, e.g., for PDCP discard timer being configured with a value close to the Packet Delay Budget (PDB) or at least being smaller than the survival time. When a packet is discarded after this timer expires and if survival time consideration is configured for the UE 112, it is seen as a triggering point for PDCP packet duplication of subsequent transmissions since, according to survival time, the application must receive subsequent packets in order to “survive”. Therefore, those subsequent transmissions should be transmitted with the extra reliability that PDCP packet duplication provides.

In another embodiment, PDCP packet duplication after the above-described activation is again deactivated when deactivation signaling from the bae station 102 (e.g., gNB) is received. In another related embodiment, it is again de-activated after a certain time. For this, a timer can be configured to again deactivate PDCP packet duplication in the UE 112. The timer value may be the survival time. If the timer is configured, it can be stopped by a PDCP packet duplication status command sent from the base station 102 (e.g., gNB) by Medium Access Control (MAC) Control Element (CE) or Radio Resource Control (RRC) reconfiguration message. In one embodiment, the timer is not re-started if the same triggered condition is met, e.g., the expiry of the PDCP discard timer. This is useful in the case when the survival time is a multiple of the configured PDCP discard timer value that are set equal to or close to the PDB.

If such timer is not considered in the UE 112, alternatively the base station (e.g., gNB) implementation can ensure that PDCP packet duplication is again deactivated after a certain time, e.g. certain time in which packets are received successfully (e.g., both duplicates and originals) by the base station (e.g., gNB).

In one embodiment, the UE 112 activates all configured but currently inactive PDCP duplication legs. In another embodiment, the UE 112 is provided with a subset of configured but inactive PDCP duplication legs, and the UE 112 activates all PDCP duplication legs in this subset. The subset can be configured by the network (e.g., RRC configured).

In another embodiment, the UE 112 is provided with a list of to-prioritize PDCP duplication legs for potential activation based on the above method—for the case that more than one duplication leg is available. The legs in a cell group, other than the cell group to which the currently activated Radio Link Control (RLC) entity is associated, may be configured with a higher priority. In one embodiment, the duplication leg considered as fallback to split bearer operation (which can be configured) is considered as this prioritized PDCP duplication leg. This is to achieve a better diversity gain by transmitting the duplicate in another cell group, as the previous packet that did not meet the delay budget can be transmitted in any cell of the same cell group and all of the cells might be in bad coverage. Also, in this embodiment, the number of PDCP duplication legs to activate (which can be smaller than the maximum number of in-active PDCP duplication legs) according to above method, may be configured for the UE 112.

In another follow-up embodiment of the previous one, one UE 112 may successively activate more PDCP duplication legs, up to the maximum number of legs that can be activated. For example, after the detection of one packet delivery expiry, the UE 112 activates one leg and, if this second packet is still not delivered, the UE 112 then activates one more leg. This is particularly useful for the use case where the survival time can be of multiple transfer intervals (such as three shown in Table 5.2-1 of 3GPP TS 22.104)

In a variant, the PDCP discard timer expiry is not considered as trigger, but another timer specific for this purpose is considered by the UE 112 to trigger activation of PDCP packet duplication.

In another variant, PDCP duplication is not activated based on this timer expiry; rather, another reliability-increasing mechanism for subsequent packets is activated. Some examples of other reliability-increasing mechanisms may be activated include, but are not limited to, more robust modulation and coding scheme, repetitions, or multiple antenna techniques.

In yet another variant, duplication transmission (or high reliability scheme) is not only applied to subsequent packets, but also to the original packet that triggered the duplication/reliability activation, e.g. this packet may be retransmitted in duplicate/reliability way. The duplication/reliability retransmission may also be applied to all other packets that followed the triggering packet in the meantime.

In another scenario, PDCP duplication can be activated already for the UE 112, for example, two RLC entities for PDCP duplications are activated. The above methods are applied for the case where additional RLC entities (e.g., up-to two more as specified in Rel-16) can be further activated based on the similar triggering conditions related with the survival time.

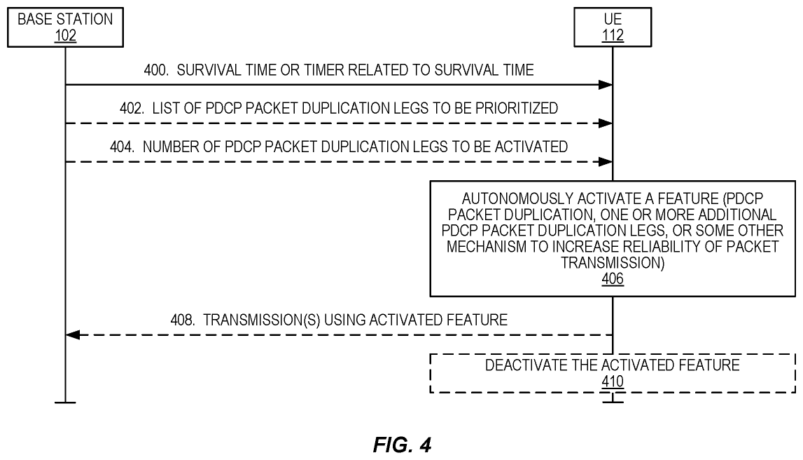

FIG. 4 illustrates the operation of a UE 112 and a base station 102 in accordance with at least some of the embodiments described above. Note that while not all of the details of the embodiments above are repeated herein in the description of FIG. 4, it should be understood that all of the details described above are applicable to the process of FIG. 4. Note that optional steps are represented by dashed lines/boxes.

As illustrated, UE 112 obtains a survival time or a timer related to survival time from the base station 102 (step 400). As discussed above, the survival time is the time that an application consuming a communication service may continue without an anticipated message. The message is anticipated at the end of the PDB, and the survival time is the maximum additional time that a message is expected after PDB. As described herein, in one embodiment, a timer related to survival time is received, where this timer is, e.g., a PDCP discard timer or a timer specifically for the purpose of autonomous activation of a feature (e.g., PDCP packet duplication, additional PDCP duplication leg(s), or some other reliability-increasing mechanism). Optionally, the UE 112 is configured (e.g., receives a configuration(s) from the base station 102 in this example) with a list of PDCP duplication legs to be prioritized for potential activation by the UE 112 (step 402). Each PDCP duplication leg is a separate carrier or cell, or more specifically an associated RLC entity, that may be activated for the UE 112 for, e.g., carrier aggregation or multi-connectivity (e.g., dual-connectivity). As discussed above, in one embodiment, duplication leg(s) in a cell group(s) other than the cell group to which the currently activated RLC entity(ies) is(are) associated to are given higher priority for potential activation by the UE 112. Note that, in one embodiment, a PDCP duplication leg that is considered as a fallback to split bearer operation (which can be configured) is considered as the prioritized PDCP duplication leg for potential activation by the UE 112. In one embodiment, the UE 112 is configured (e.g., receive a configuration message(s) from the base station 102 in this example) with a number of PDCP duplication legs to potentially be activated by the UE 112 (step 404).

The UE 112 autonomously activates PDCP packet duplication, activates additional PDCP duplication leg(s), or activates some other reliability-increasing mechanism for subsequent packets (and optionally the current packet) based on a trigger (e.g., a trigger related to the survival time) (step 406). As discussed above, in one embodiment, the trigger is expiry of a PDCP discard timer. In another embodiment, the trigger is expiry of some other timer (e.g., defined for the purpose of autonomous activation of PDCP packet duplication, additional PDCP duplication leg(s), or some other reliability-increasing mechanism). As discussed above, in regard to activation of PDCP packet duplication, in one embodiment, the UE 112 activates all configured but currently inactive PDCP duplication legs. In another embodiment, the UE 112 activates a subset of the configured but currently inactive PDCP duplication legs. This subset may be determined, e.g., based on the configured list of PDCP duplication legs from step 402 and/or the number of PDCP duplication legs to be configured from step 404. The UE 112 transmits packet(s) (e.g., subsequent packet(s)) using the activated feature (step 408). As discussed above, in one embodiment, the UE 112 iteratively actives more PDCP duplication legs until packet transmission is successful.

Optionally, the UE 112 subsequently deactivates PDCP packet duplication, the additional activated PDCP duplication leg(s), or the other reliability-increasing mechanism that was activated in step 406 (step 410). As discussed above, in one embodiment, the UE 112 performs this deactivation in response to signaling from the base station 102. In another embodiment, the UE 112 performs this deactivation based on expiry of a timer.

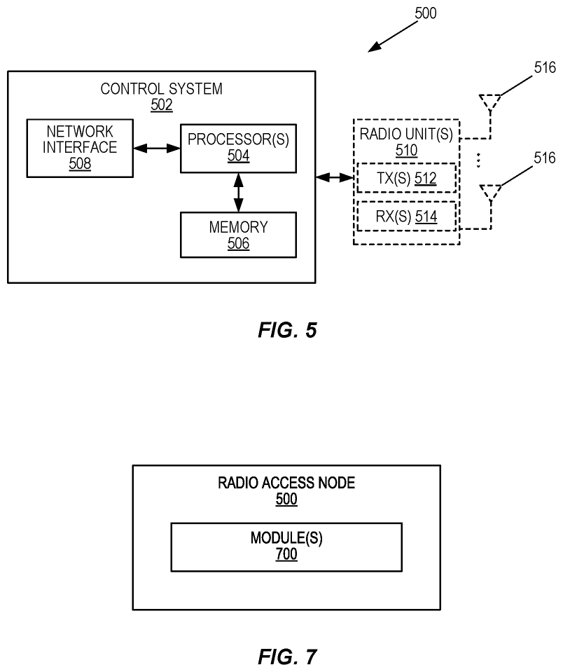

FIG. 5 is a schematic block diagram of a radio access node 500 according to some embodiments of the present disclosure. Optional features are represented by dashed boxes. The radio access node 500 may be, for example, a base station 102 or 106 or a network node that implements all or part of the functionality of the base station 102 or gNB described herein. As illustrated, the radio access node 500 includes a control system 502 that includes one or more processors 504 (e.g., Central Processing Units (CPUs), Application Specific Integrated Circuits (ASICs), Field Programmable Gate Arrays (FPGAs), and/or the like), memory 506, and a network interface 508. The one or more processors 504 are also referred to herein as processing circuitry. In addition, the radio access node 500 may include one or more radio units 510 that each includes one or more transmitters 512 and one or more receivers 514 coupled to one or more antennas 516. The radio units 510 may be referred to or be part of radio interface circuitry. In some embodiments, the radio unit(s) 510 is external to the control system 502 and connected to the control system 502 via, e.g., a wired connection (e.g., an optical cable). However, in some other embodiments, the radio unit(s) 510 and potentially the antenna(s) 516 are integrated together with the control system 502. The one or more processors 504 operate to provide one or more functions of the radio access node 500 as described herein (e.g., one or more functions of the base station 102 or other RAN node as described herein). In some embodiments, the function(s) are implemented in software that is stored, e.g., in the memory 506 and executed by the one or more processors 504.

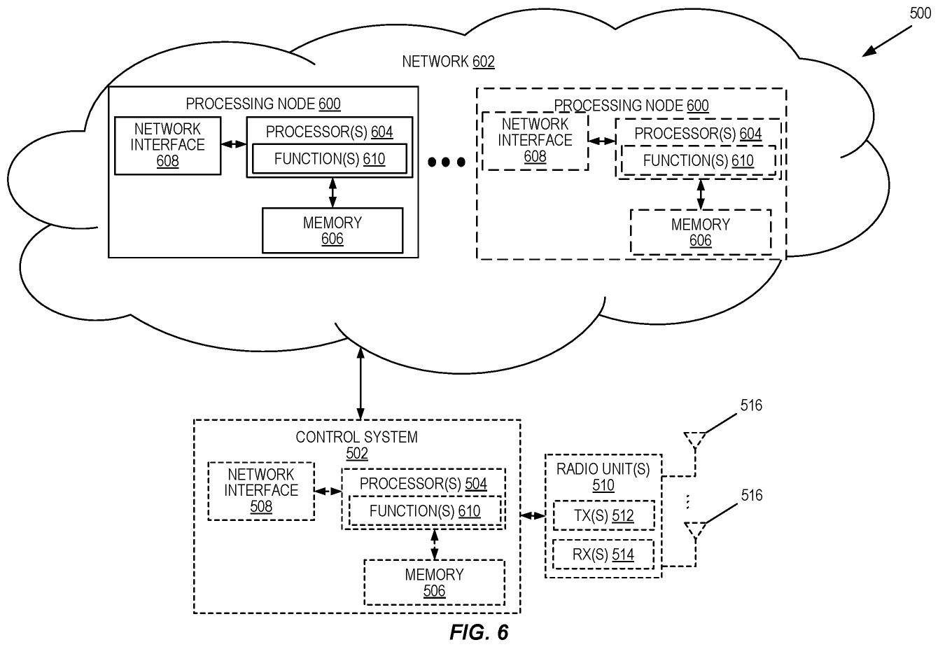

FIG. 6 is a schematic block diagram that illustrates a virtualized embodiment of the radio access node 500 according to some embodiments of the present disclosure. This discussion is equally applicable to other types of network nodes. Further, other types of network nodes may have similar virtualized architectures. Again, optional features are represented by dashed boxes.

As used herein, a “virtualized” radio access node is an implementation of the radio access node 500 in which at least a portion of the functionality of the radio access node 500 is implemented as a virtual component(s) (e.g., via a virtual machine(s) executing on a physical processing node(s) in a network(s)). As illustrated, in this example, the radio access node 500 may include the control system 502 and/or the one or more radio units 510, as described above. The control system 502 may be connected to the radio unit(s) 510 via, for example, an optical cable or the like. The radio access node 500 includes one or more processing nodes 600 coupled to or included as part of a network(s) 602. If present, the control system 502 or the radio unit(s) are connected to the processing node(s) 600 via the network 602. Each processing node 600 includes one or more processors 604 (e.g., CPUs, ASICs, FPGAs, and/or the like), memory 606, and a network interface 608.

In this example, functions 610 of the radio access node 500 described herein (e.g., one or more functions of the base station 102 or other RAN node as described herein) are implemented at the one or more processing nodes 600 or distributed across the one or more processing nodes 600 and the control system 502 and/or the radio unit(s) 510 in any desired manner. In some particular embodiments, some or all of the functions 610 of the radio access node 500 described herein are implemented as virtual components executed by one or more virtual machines implemented in a virtual environment(s) hosted by the processing node(s) 600. As will be appreciated by one of ordinary skill in the art, additional signaling or communication between the processing node(s) 600 and the control system 502 is used in order to carry out at least some of the desired functions 610. Notably, in some embodiments, the control system 502 may not be included, in which case the radio unit(s) 510 communicate directly with the processing node(s) 600 via an appropriate network interface(s).

In some embodiments, a computer program including instructions which, when executed by at least one processor, causes the at least one processor to carry out the functionality of radio access node 500 or a node (e.g., a processing node 600) implementing one or more of the functions 610 of the radio access node 500 in a virtual environment according to any of the embodiments described herein is provided. In some embodiments, a carrier comprising the aforementioned computer program product is provided. The carrier is one of an electronic signal, an optical signal, a radio signal, or a computer readable storage medium (e.g., a non-transitory computer readable medium such as memory).

FIG. 7 is a schematic block diagram of the radio access node 500 according to some other embodiments of the present disclosure. The radio access node 500 includes one or more modules 700, each of which is implemented in software. The module(s) 700 provide the functionality of the radio access node 500 described herein (e.g., one or more functions of the base station 102 or other RAN node as described herein). This discussion is equally applicable to the processing node 600 of FIG. 6 where the modules 700 may be implemented at one of the processing nodes 600 or distributed across multiple processing nodes 600 and/or distributed across the processing node(s) 600 and the control system 502.

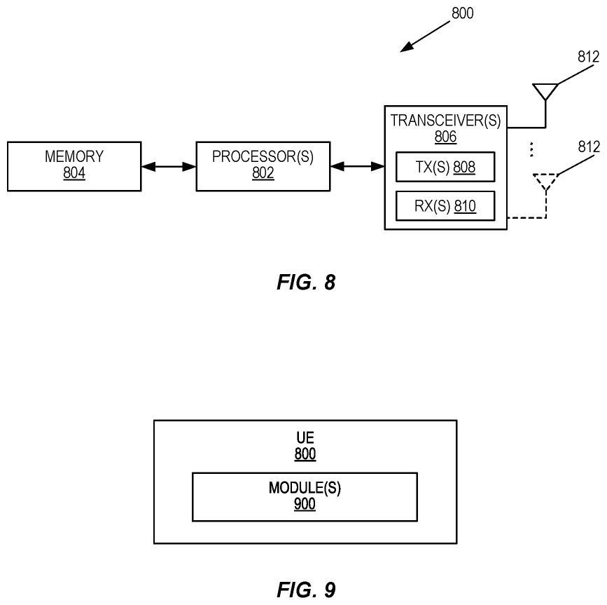

FIG. 8 is a schematic block diagram of a wireless communication device 800 according to some embodiments of the present disclosure. The wireless communication device 800 may be, for example, the UE 112. As illustrated, the wireless communication device 800 includes one or more processors 802 (e.g., CPUs, ASICs, FPGAs, and/or the like), memory 804, and one or more transceivers 806 each including one or more transmitters 808 and one or more receivers 810 coupled to one or more antennas 812. The transceiver(s) 806 includes radio-front end circuitry connected to the antenna(s) 812 that is configured to condition signals communicated between the antenna(s) 812 and the processor(s) 802, as will be appreciated by on of ordinary skill in the art. The processors 802 are also referred to herein as processing circuitry. The transceivers 806 are also referred to herein as radio circuitry. In some embodiments, the functionality of the wireless communication device 800 described above (e.g., functionality of the UE 112 described above) may be fully or partially implemented in software that is, e.g., stored in the memory 804 and executed by the processor(s) 802. Note that the wireless communication device 800 may include additional components not illustrated in FIG. 8 such as, e.g., one or more user interface components (e.g., an input/output interface including a display, buttons, a touch screen, a microphone, a speaker(s), and/or the like and/or any other components for allowing input of information into the wireless communication device 800 and/or allowing output of information from the wireless communication device 800), a power supply (e.g., a battery and associated power circuitry), etc.

In some embodiments, a computer program including instructions which, when executed by at least one processor, causes the at least one processor to carry out the functionality of the wireless communication device 800 according to any of the embodiments described herein is provided. In some embodiments, a carrier comprising the aforementioned computer program product is provided. The carrier is one of an electronic signal, an optical signal, a radio signal, or a computer readable storage medium (e.g., a non-transitory computer readable medium such as memory).

FIG. 9 is a schematic block diagram of the wireless communication device 800 according to some other embodiments of the present disclosure. The wireless communication device 800 includes one or more modules 900, each of which is implemented in software. The module(s) 900 provide the functionality of the wireless communication device 800 described herein (e.g., functionality of the UE 112 described above).

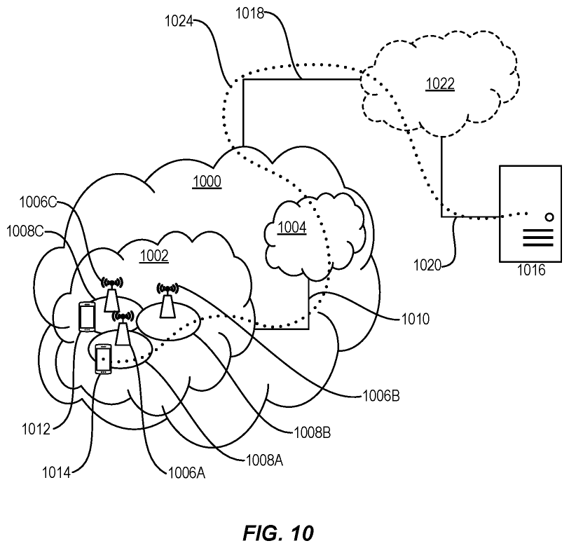

With reference to FIG. 10, in accordance with an embodiment, a communication system includes a telecommunication network 1000, such as a 3GPP-type cellular network, which comprises an access network 1002, such as a RAN, and a core network 1004. The access network 1002 comprises a plurality of base stations 1006A, 1006B, 1006C, such as Node Bs, eNBs, gNBs, or other types of wireless Access Points (APs), each defining a corresponding coverage area 1008A, 1008B, 1008C. Each base station 1006A, 1006B, 1006C is connectable to the core network 1004 over a wired or wireless connection 1010. A first UE 1012 located in coverage area 1008C is configured to wirelessly connect to, or be paged by, the corresponding base station 1006C. A second UE 1014 in coverage area 1008A is wirelessly connectable to the corresponding base station 1006A. While a plurality of UEs 1012, 1014 are illustrated in this example, the disclosed embodiments are equally applicable to a situation where a sole UE is in the coverage area or where a sole UE is connecting to the corresponding base station 1006.

The telecommunication network 1000 is itself connected to a host computer 1016, which may be embodied in the hardware and/or software of a standalone server, a cloud-implemented server, a distributed server, or as processing resources in a server farm. The host computer 1016 may be under the ownership or control of a service provider, or may be operated by the service provider or on behalf of the service provider. Connections 1018 and 1020 between the telecommunication network 1000 and the host computer 1016 may extend directly from the core network 1004 to the host computer 1016 or may go via an optional intermediate network 1022. The intermediate network 1022 may be one of, or a combination of more than one of, a public, private, or hosted network; the intermediate network 1022, if any, may be a backbone network or the Internet; in particular, the intermediate network 1022 may comprise two or more sub-networks (not shown).

The communication system of FIG. 10 as a whole enables connectivity between the connected UEs 1012, 1014 and the host computer 1016. The connectivity may be described as an Over-the-Top (OTT) connection 1024. The host computer 1016 and the connected UEs 1012, 1014 are configured to communicate data and/or signaling via the OTT connection 1024, using the access network 1002, the core network 1004, any intermediate network 1022, and possible further infrastructure (not shown) as intermediaries. The OTT connection 1024 may be transparent in the sense that the participating communication devices through which the OTT connection 1024 passes are unaware of routing of uplink and downlink communications. For example, the base station 1006 may not or need not be informed about the past routing of an incoming downlink communication with data originating from the host computer 1016 to be forwarded (e.g., handed over) to a connected UE 1012. Similarly, the base station 1006 need not be aware of the future routing of an outgoing uplink communication originating from the UE 1012 towards the host computer 1016.

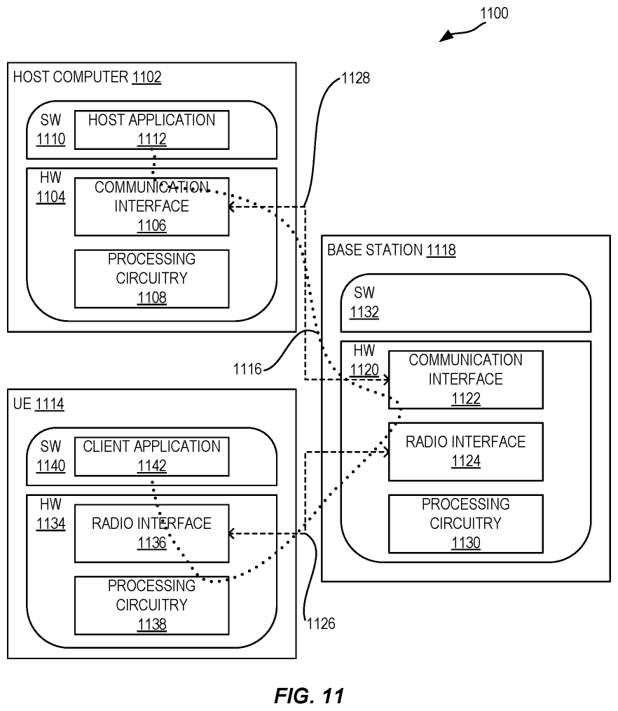

Example implementations, in accordance with an embodiment, of the UE, base station, and host computer discussed in the preceding paragraphs will now be described with reference to FIG. 11. In a communication system 1100, a host computer 1102 comprises hardware 1104 including a communication interface 1106 configured to set up and maintain a wired or wireless connection with an interface of a different communication device of the communication system 1100. The host computer 1102 further comprises processing circuitry 1108, which may have storage and/or processing capabilities. In particular, the processing circuitry 1108 may comprise one or more programmable processors, ASICs, FPGAs, or combinations of these (not shown) adapted to execute instructions. The host computer 1102 further comprises software 1110, which is stored in or accessible by the host computer 1102 and executable by the processing circuitry 1108. The software 1110 includes a host application 1112. The host application 1112 may be operable to provide a service to a remote user, such as a UE 1114 connecting via an OTT connection 1116 terminating at the UE 1114 and the host computer 1102. In providing the service to the remote user, the host application 1112 may provide user data which is transmitted using the OTT connection 1116.

The communication system 1100 further includes a base station 1118 provided in a telecommunication system and comprising hardware 1120 enabling it to communicate with the host computer 1102 and with the UE 1114. The hardware 1120 may include a communication interface 1122 for setting up and maintaining a wired or wireless connection with an interface of a different communication device of the communication system 1100, as well as a radio interface 1124 for setting up and maintaining at least a wireless connection 1126 with the UE 1114 located in a coverage area (not shown in FIG. 11) served by the base station 1118. The communication interface 1122 may be configured to facilitate a connection 1128 to the host computer 1102. The connection 1128 may be direct or it may pass through a core network (not shown in FIG. 11) of the telecommunication system and/or through one or more intermediate networks outside the telecommunication system. In the embodiment shown, the hardware 1120 of the base station 1118 further includes processing circuitry 1130, which may comprise one or more programmable processors, ASICs, FPGAs, or combinations of these (not shown) adapted to execute instructions. The base station 1118 further has software 1132 stored internally or accessible via an external connection.

The communication system 1100 further includes the UE 1114 already referred to. The UE's 1114 hardware 1134 may include a radio interface 1136 configured to set up and maintain a wireless connection 1126 with a base station serving a coverage area in which the UE 1114 is currently located. The hardware 1134 of the UE 1114 further includes processing circuitry 1138, which may comprise one or more programmable processors, ASICs, FPGAs, or combinations of these (not shown) adapted to execute instructions. The UE 1114 further comprises software 1140, which is stored in or accessible by the UE 1114 and executable by the processing circuitry 1138. The software 1140 includes a client application 1142. The client application 1142 may be operable to provide a service to a human or non-human user via the UE 1114, with the support of the host computer 1102. In the host computer 1102, the executing host application 1112 may communicate with the executing client application 1142 via the OTT connection 1116 terminating at the UE 1114 and the host computer 1102. In providing the service to the user, the client application 1142 may receive request data from the host application 1112 and provide user data in response to the request data. The OTT connection 1116 may transfer both the request data and the user data. The client application 1142 may interact with the user to generate the user data that it provides.

It is noted that the host computer 1102, the base station 1118, and the UE 1114 illustrated in FIG. 11 may be similar or identical to the host computer 1016, one of the base stations 1006A, 1006B, 1006C, and one of the UEs 1012, 1014 of FIG. 10, respectively. This is to say, the inner workings of these entities may be as shown in FIG. 11 and independently, the surrounding network topology may be that of FIG. 10.

In FIG. 11, the OTT connection 1116 has been drawn abstractly to illustrate the communication between the host computer 1102 and the UE 1114 via the base station 1118 without explicit reference to any intermediary devices and the precise routing of messages via these devices. The network infrastructure may determine the routing, which may be configured to hide from the UE 1114 or from the service provider operating the host computer 1102, or both. While the OTT connection 1116 is active, the network infrastructure may further take decisions by which it dynamically changes the routing (e.g., on the basis of load balancing consideration or reconfiguration of the network).

The wireless connection 1126 between the UE 1114 and the base station 1118 is in accordance with the teachings of the embodiments described throughout this disclosure. One or more of the various embodiments improve the performance of OTT services provided to the UE 1114 using the OTT connection 1116, in which the wireless connection 1126 forms the last segment. More precisely, the teachings of these embodiments may improve, e.g., reliability and thereby provide benefits such as, e.g., better responsiveness or better user experience.

A measurement procedure may be provided for the purpose of monitoring data rate, latency, and other factors on which the one or more embodiments improve. There may further be an optional network functionality for reconfiguring the OTT connection 1116 between the host computer 1102 and the UE 1114, in response to variations in the measurement results. The measurement procedure and/or the network functionality for reconfiguring the OTT connection 1116 may be implemented in the software 1110 and the hardware 1104 of the host computer 1102 or in the software 1140 and the hardware 1134 of the UE 1114, or both. In some embodiments, sensors (not shown) may be deployed in or in association with communication devices through which the OTT connection 1116 passes; the sensors may participate in the measurement procedure by supplying values of the monitored quantities exemplified above, or supplying values of other physical quantities from which the software 1110, 1140 may compute or estimate the monitored quantities. The reconfiguring of the OTT connection 1116 may include message format, retransmission settings, preferred routing, etc.; the reconfiguring need not affect the base station 1118, and it may be unknown or imperceptible to the base station 1118. Such procedures and functionalities may be known and practiced in the art. In certain embodiments, measurements may involve proprietary UE signaling facilitating the host computer 1102's measurements of throughput, propagation times, latency, and the like. The measurements may be implemented in that the software 1110 and 1140 causes messages to be transmitted, in particular empty or ‘dummy’ messages, using the OTT connection 1116 while it monitors propagation times, errors, etc.

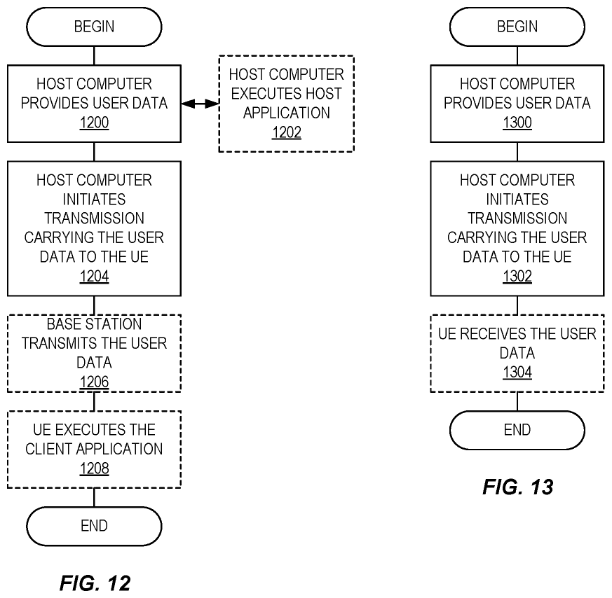

FIG. 12 is a flowchart illustrating a method implemented in a communication system, in accordance with one embodiment. The communication system includes a host computer, a base station, and a UE which may be those described with reference to FIGS. 10 and 11. For simplicity of the present disclosure, only drawing references to FIG. 12 will be included in this section. In step 1200, the host computer provides user data. In sub-step 1202 (which may be optional) of step 1200, the host computer provides the user data by executing a host application. In step 1204, the host computer initiates a transmission carrying the user data to the UE. In step 1206 (which may be optional), the base station transmits to the UE the user data which was carried in the transmission that the host computer initiated, in accordance with the teachings of the embodiments described throughout this disclosure. In step 1208 (which may also be optional), the UE executes a client application associated with the host application executed by the host computer.

FIG. 13 is a flowchart illustrating a method implemented in a communication system, in accordance with one embodiment. The communication system includes a host computer, a base station, and a UE which may be those described with reference to FIGS. 10 and 11. For simplicity of the present disclosure, only drawing references to FIG. 13 will be included in this section. In step 1300 of the method, the host computer provides user data. In an optional sub-step (not shown) the host computer provides the user data by executing a host application. In step 1302, the host computer initiates a transmission carrying the user data to the UE. The transmission may pass via the base station, in accordance with the teachings of the embodiments described throughout this disclosure. In step 1304 (which may be optional), the UE receives the user data carried in the transmission.

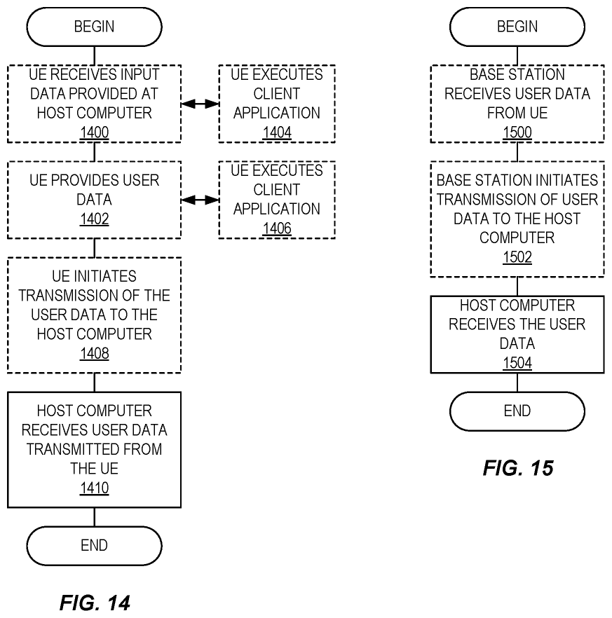

FIG. 14 is a flowchart illustrating a method implemented in a communication system, in accordance with one embodiment. The communication system includes a host computer, a base station, and a UE which may be those described with reference to FIGS. 10 and 11. For simplicity of the present disclosure, only drawing references to FIG. 14 will be included in this section. In step 1400 (which may be optional), the UE receives input data provided by the host computer. Additionally or alternatively, in step 1402, the UE provides user data. In sub-step 1404 (which may be optional) of step 1400, the UE provides the user data by executing a client application. In sub-step 1406 (which may be optional) of step 1402, the UE executes a client application which provides the user data in reaction to the received input data provided by the host computer. In providing the user data, the executed client application may further consider user input received from the user. Regardless of the specific manner in which the user data was provided, the UE initiates, in sub-step 1408 (which may be optional), transmission of the user data to the host computer. In step 1410 of the method, the host computer receives the user data transmitted from the UE, in accordance with the teachings of the embodiments described throughout this disclosure.

FIG. 15 is a flowchart illustrating a method implemented in a communication system, in accordance with one embodiment. The communication system includes a host computer, a base station, and a UE which may be those described with reference to FIGS. 10 and 11. For simplicity of the present disclosure, only drawing references to FIG. 15 will be included in this section. In step 1500 (which may be optional), in accordance with the teachings of the embodiments described throughout this disclosure, the base station receives user data from the UE. In step 1502 (which may be optional), the base station initiates transmission of the received user data to the host computer. In step 1504 (which may be optional), the host computer receives the user data carried in the transmission initiated by the base station.

Any appropriate steps, methods, features, functions, or benefits disclosed herein may be performed through one or more functional units or modules of one or more virtual apparatuses. Each virtual apparatus may comprise a number of these functional units. These functional units may be implemented via processing circuitry, which may include one or more microprocessor or microcontrollers, as well as other digital hardware, which may include Digital Signal Processor (DSPs), special-purpose digital logic, and the like. The processing circuitry may be configured to execute program code stored in memory, which may include one or several types of memory such as Read Only Memory (ROM), Random Access Memory (RAM), cache memory, flash memory devices, optical storage devices, etc. Program code stored in memory includes program instructions for executing one or more telecommunications and/or data communications protocols as well as instructions for carrying out one or more of the techniques described herein. In some implementations, the processing circuitry may be used to cause the respective functional unit to perform corresponding functions according one or more embodiments of the present disclosure.

While processes in the figures may show a particular order of operations performed by certain embodiments of the present disclosure, it should be understood that such order is exemplary (e.g., alternative embodiments may perform the operations in a different order, combine certain operations, overlap certain operations, etc.).

Some example embodiments of the present disclosure are as follows:

### Group A Embodiments

Embodiment 1: A method performed by a wireless communication device (112), comprising: obtaining (400) a survival time, the survival time being an amount of time that an application consuming a communication service may continue without an anticipated message; and autonomously activating (406) a feature based on the survival time, the feature being PDCP packet duplication, one or more additional PDCP packet duplication legs in a case where PDCP packet duplication is already activated, or some other mechanism that increases reliability of packet transmission.

Embodiment 2: The method of embodiment 1 wherein a PDCP packet duplication leg is an RLC entity to which PDCP duplication is activated.

Embodiment 3: The method embodiment 1 or 2 further comprising transmitting (408) one or more packets using the activated feature.

Embodiment 4: The method any of embodiments 1 to 3 wherein autonomously activating (406) comprises autonomously activating (406) responsive to a trigger.

Embodiment 5: The method of embodiment 4 wherein the trigger is expiry of a PDCP discard timer.

Embodiment 6: The method of embodiment 4 wherein the trigger is expiry of a timer.

Embodiment 7: The method of embodiment 4 wherein the trigger is expiry of a timer defined specifically for autonomous activation of PDCP packet duplication, one or more additional PDCP packet duplication legs in a case where PDCP packet duplication is already activated, or some other mechanism that increases reliability of packet transmission.

Embodiment 8: The method of any of embodiments 1 to 7 wherein autonomously activating (406) the feature comprises autonomously activating PDCP packet duplication or one or more additional PDCP packet duplication legs.

Embodiment 9: The method of embodiment 8 wherein autonomously activating PDCP packet duplication or one or more additional PDCP packet duplication legs comprises autonomously activating all configured but currently inactive PDCP packet duplication legs.

Embodiment 10: The method of embodiment 8 wherein autonomously activating PDCP packet duplication or one or more additional PDCP packet duplication legs comprises autonomously activating a subset of all configured but currently inactive PDCP packet duplication legs.

Embodiment 11: The method of embodiment 10 wherein the subset of all configured but currently inactivate PDCP packet duplication legs comprises one or more PDCP packet duplication legs associated to one or more cell groups other than a cell group to which an existing, activated RLC entity belongs.

Embodiment 12: The method of any of embodiments 8 to 11 wherein autonomously activating PDCP packet duplication or one or more additional PDCP packet duplication legs comprises autonomously activating PDCP packet duplication or one or more additional PDCP packet duplication legs based on priorities associated to PDCP packet duplication legs.

Embodiment 13: The method of any of embodiments 8 to 12 wherein autonomously activating PDCP packet duplication or one or more additional PDCP packet duplication legs comprises autonomously activating PDCP packet duplication or one or more additional PDCP packet duplication legs based on a predefined or configured number of PDCP packet duplication legs to be activated.

Embodiment 14: The method of any of embodiments 8 to 12 wherein autonomously activating PDCP packet duplication or one or more additional PDCP packet duplication legs comprises autonomously activating PDCP packet duplication using a PDCP packet duplication leg that is a fallback for split radio bearer operation.

Embodiment 15: The method of any of embodiments 1 to 14 further comprising deactivating (408) the activated feature.

Embodiment 16: The method of embodiment 15 wherein deactivating (408) the activated feature comprises deactivating (408) the activated feature in response to signaling from a network node.

Embodiment 17: The method of embodiment 15 wherein deactivating (408) the activated feature comprises deactivating (408) the activated feature responsive to expiry of a timer.

Embodiment 18: The method of any of the previous embodiments, further comprising: providing user data; and forwarding the user data to a host computer via the transmission to the base station.

### Group B Embodiments

Embodiment 19: A method performed by a base station (102) comprising: providing (400) a survival time to a wireless communication device (112), the survival time being an amount of time that an application consuming a communication service may continue without an anticipated message; and providing (402-404), to the wireless communication device (112), one or more parameters related to autonomous activation of a feature at the wireless communication device (112), the feature being PDCP packet duplication, one or more additional PDCP packet duplication legs in a case where PDCP packet duplication is already activated, or some other mechanism that increases reliability of packet transmission.

Embodiment 20: The method of embodiment 19 wherein a PDCP packet duplication leg is an RLC entity to which PDCP duplication is activated.

Embodiment 21: The method of embodiment 19 or 20 wherein the one or more parameters comprise information (e.g., a list) that identifies one or more PDCP packet duplication legs to be prioritized by the wireless communication device (112) for autonomous PDCP activation or autonomous activation of one or more additional PDCP packet duplication legs.

Embodiment 22: The method of any of embodiments 19 to 21 wherein the one or more parameters comprise information that indicates a number of PDCP packet duplication legs that can be activated by the wireless communication device (112) for autonomous PDCP activation or autonomous activation of one or more additional PDCP packet duplication legs.

Embodiment 23: The method of any of the previous embodiments, further comprising: obtaining user data; and forwarding the user data to a host computer or a wireless communication device.

### Group C Embodiments

Embodiment 24: A wireless communication device comprising: processing circuitry configured to perform any of the steps of any of the Group A embodiments; and power supply circuitry configured to supply power to the wireless communication device.

Embodiment 25: A base station comprising: processing circuitry configured to perform any of the steps of any of the Group B embodiments; and power supply circuitry configured to supply power to the base station.

Embodiment 26: A User Equipment, UE, comprising: an antenna configured to send and receive wireless signals; radio front-end circuitry connected to the antenna and to processing circuitry, and configured to condition signals communicated between the antenna and the processing circuitry; the processing circuitry being configured to perform any of the steps of any of the Group A embodiments; an input interface connected to the processing circuitry and configured to allow input of information into the UE to be processed by the processing circuitry; an output interface connected to the processing circuitry and configured to output information from the UE that has been processed by the processing circuitry; and a battery connected to the processing circuitry and configured to supply power to the UE.

Embodiment 27: A communication system including a host computer comprising: processing circuitry configured to provide user data; and a communication interface configured to forward the user data to a cellular network for transmission to a User Equipment, UE; wherein the cellular network comprises a base station having a radio interface and processing circuitry, the base station's processing circuitry configured to perform any of the steps of any of the Group B embodiments.

Embodiment 28: The communication system of the previous embodiment further including the base station.

Embodiment 29: The communication system of the previous 2 embodiments, further including the UE, wherein the UE is configured to communicate with the base station.

Embodiment 30: The communication system of the previous 3 embodiments, wherein: the processing circuitry of the host computer is configured to execute a host application, thereby providing the user data; and the UE comprises processing circuitry configured to execute a client application associated with the host application.

Embodiment 31: A method implemented in a communication system including a host computer, a base station, and a User Equipment, UE, the method comprising: at the host computer, providing user data; and at the host computer, initiating a transmission carrying the user data to the UE via a cellular network comprising the base station, wherein the base station performs any of the steps of any of the Group B embodiments.

Embodiment 32: The method of the previous embodiment, further comprising, at the base station, transmitting the user data.

Embodiment 33: The method of the previous 2 embodiments, wherein the user data is provided at the host computer by executing a host application, the method further comprising, at the UE, executing a client application associated with the host application.

Embodiment 34: A User Equipment, UE, configured to communicate with a base station, the UE comprising a radio interface and processing circuitry configured to perform the method of the previous 3 embodiments.

Embodiment 35: A communication system including a host computer comprising: processing circuitry configured to provide user data; and a communication interface configured to forward user data to a cellular network for transmission to a User Equipment, UE; wherein the UE comprises a radio interface and processing circuitry, the UE's components configured to perform any of the steps of any of the Group A embodiments.

Embodiment 36: The communication system of the previous embodiment, wherein the cellular network further includes a base station configured to communicate with the UE.

Embodiment 37: The communication system of the previous 2 embodiments, wherein: the processing circuitry of the host computer is configured to execute a host application, thereby providing the user data; and the UE's processing circuitry is configured to execute a client application associated with the host application.

Embodiment 38: A method implemented in a communication system including a host computer, a base station, and a User Equipment, UE, the method comprising: at the host computer, providing user data; and at the host computer, initiating a transmission carrying the user data to the UE via a cellular network comprising the base station, wherein the UE performs any of the steps of any of the Group A embodiments.

Embodiment 39: The method of the previous embodiment, further comprising at the UE, receiving the user data from the base station.

Embodiment 40: A communication system including a host computer comprising: communication interface configured to receive user data originating from a transmission from a User Equipment, UE, to a base station; wherein the UE comprises a radio interface and processing circuitry, the UE's processing circuitry configured to perform any of the steps of any of the Group A embodiments.

Embodiment 41: The communication system of the previous embodiment, further including the UE.

Embodiment 42: The communication system of the previous 2 embodiments, further including the base station, wherein the base station comprises a radio interface configured to communicate with the UE and a communication interface configured to forward to the host computer the user data carried by a transmission from the UE to the base station.

Embodiment 43: The communication system of the previous 3 embodiments, wherein: the processing circuitry of the host computer is configured to execute a host application; and the UE's processing circuitry is configured to execute a client application associated with the host application, thereby providing the user data.

Embodiment 44: The communication system of the previous 4 embodiments, wherein: the processing circuitry of the host computer is configured to execute a host application, thereby providing request data; and the UE's processing circuitry is configured to execute a client application associated with the host application, thereby providing the user data in response to the request data.

Embodiment 45: A method implemented in a communication system including a host computer, a base station, and a User Equipment, UE, the method comprising: at the host computer, receiving user data transmitted to the base station from the UE, wherein the UE performs any of the steps of any of the Group A embodiments.

Embodiment 46: The method of the previous embodiment, further comprising, at the UE, providing the user data to the base station.

Embodiment 47: The method of the previous 2 embodiments, further comprising: at the UE, executing a client application, thereby providing the user data to be transmitted; and at the host computer, executing a host application associated with the client application.

Embodiment 48: The method of the previous 3 embodiments, further comprising: at the UE, executing a client application; and at the UE, receiving input data to the client application, the input data being provided at the host computer by executing a host application associated with the client application; wherein the user data to be transmitted is provided by the client application in response to the input data.

Embodiment 49: A communication system including a host computer comprising a communication interface configured to receive user data originating from a transmission from a User Equipment, UE, to a base station, wherein the base station comprises a radio interface and processing circuitry, the base station's processing circuitry configured to perform any of the steps of any of the Group B embodiments.

Embodiment 50: The communication system of the previous embodiment further including the base station.

Embodiment 51: The communication system of the previous 2 embodiments, further including the UE, wherein the UE is configured to communicate with the base station.

Embodiment 52: The communication system of the previous 3 embodiments, wherein: the processing circuitry of the host computer is configured to execute a host application; and the UE is configured to execute a client application associated with the host application, thereby providing the user data to be received by the host computer.

Embodiment 53: A method implemented in a communication system including a host computer, a base station, and a User Equipment, UE, the method comprising: at the host computer, receiving, from the base station, user data originating from a transmission which the base station has received from the UE, wherein the UE performs any of the steps of any of the Group A embodiments.

Embodiment 54: The method of the previous embodiment, further comprising at the base station, receiving the user data from the UE.

Embodiment 55: The method of the previous 2 embodiments, further comprising at the base station, initiating a transmission of the received user data to the host computer.

Those skilled in the art will recognize improvements and modifications to the embodiments of the present disclosure. All such improvements and modifications are considered within the scope of the concepts disclosed herein.

1. A method performed by a wireless communication device, comprising:
obtaining a timer related to survival time, the survival time being an amount of time that an application consuming a communication service may continue without an anticipated message; and
autonomously activating a feature based on the timer, the feature being Packet Data Convergence Protocol, PDCP, packet duplication, one or more additional PDCP packet duplication legs in a case where PDCP packet duplication is already activated, or another mechanism that increases reliability of packet transmission;
where the timer is a PDCP discard timer, and autonomously activating the feature based on the timer comprises autonomously activating the feature upon discarding a packet upon expiry of the PDCP timer.

2. The method of claim 1 wherein the PDCP discard timer value is configured with a value equal to the Packet Delay Budget, PDB.

3. The method of claim 1 wherein the timer is a timer that is specific for the purpose of activating the feature, and autonomously activating the feature based on the timer comprises autonomously activating the feature upon expiry of the timer.

4. The method of claim 1 wherein a PDCP packet duplication leg is a Radio Link Control, RLC, entity to which PDCP duplication is activated.

5. The method of claim 1 further comprising transmitting one or more packets using the activated feature.

6. The method of claim 1 wherein autonomously activating the feature comprises autonomously activating PDCP packet duplication or one or more additional PDCP packet duplication legs.

7. The method of claim 6 wherein autonomously activating PDCP packet duplication or one or more additional PDCP packet duplication legs comprises autonomously activating all configured but currently inactive PDCP packet duplication legs.

8. The method of claim 6 wherein autonomously activating PDCP packet duplication or one or more additional PDCP packet duplication legs comprises autonomously activating a subset of all configured but currently inactive PDCP packet duplication legs.

9. The method of claim 8 wherein the subset of all configured but currently inactivate PDCP packet duplication legs comprises one or more PDCP packet duplication legs associated to one or more cell groups other than a cell group to which an existing, activated RLC entity belongs.

10. The method of claim 6 wherein autonomously activating PDCP packet duplication or one or more additional PDCP packet duplication legs comprises successively activating one or more additional PDCP packet duplication legs.

11. The method of claim 6 wherein autonomously activating PDCP packet duplication or one or more additional PDCP packet duplication legs comprises autonomously activating PDCP packet duplication or one or more additional PDCP packet duplication legs based on priorities associated to PDCP packet duplication legs.

12. The method of claim 6 wherein autonomously activating PDCP packet duplication or one or more additional PDCP packet duplication legs comprises autonomously activating PDCP packet duplication or one or more additional PDCP packet duplication legs based on a predefined or configured number of PDCP packet duplication legs to be activated.

13. The method of claim 6 wherein autonomously activating PDCP packet duplication or one or more additional PDCP packet duplication legs comprises autonomously activating PDCP packet duplication using a PDCP packet duplication leg that is a fallback for split radio bearer operation.

14. The method of claim 1 further comprising deactivating the activated feature.

15. The method of claim 14 wherein deactivating the activated feature comprises deactivating the activated feature in response to signaling from a network node.

16. The method of claim 14 wherein deactivating the activated feature comprises deactivating the activated feature responsive to expiry of a timer.

17. A wireless communication device adapted to:
obtain a timer related to survival time, the survival time being an amount of time that an application consuming a communication service may continue without an anticipated message; and
autonomously activate a feature based on the timer, the feature being Packet Data Convergence Protocol, PDCP, packet duplication, one or more additional PDCP packet duplication legs in a case where PDCP packet duplication is already activated, or another mechanism that increases reliability of packet transmission;
where the timer is a PDCP discard timer, and autonomously activating the feature based on the timer comprises being adapted to autonomously activate the feature upon discarding a packet upon expiry of the PDCP timer.

18. (canceled)

19. A wireless communication device comprising:
one or more transmitters;
one or more receivers; and
processing circuitry associated with the one or more transmitters and the one or more receivers, the processing circuitry configured to cause the wireless communication device to:
obtain a timer related to survival time, the survival time being an amount of time that an application consuming a communication service may continue without an anticipated message; and
autonomously activate a feature based on the timer, the feature being Packet Data Convergence Protocol, PDCP, packet duplication, one or more additional PDCP packet duplication legs in a case where PDCP packet duplication is already activated, or another mechanism that increases reliability of packet transmission;
where the timer is a PDCP discard timer, and autonomously activating the feature based on the timer comprises the processing circuitry being configured to cause the wireless communication device to autonomously activate the feature upon discarding a packet upon expiry of the PDCP timer.

20. (canceled)

21. A method performed by a base station comprising:
providing a timer related to survival time to a wireless communication device, the survival time being an amount of time that an application consuming a communication service may continue without an anticipated message; and
providing, to the wireless communication device, one or more parameters related to autonomous activation of a feature at the wireless communication device, the feature being Packet Detection Convergence Protocol, PDCP, packet duplication, one or more additional PDCP packet duplication legs in a case where PDCP packet duplication is already activated, or some other mechanism that increases reliability of packet transmission;
where the timer is a PDCP discard timer, and autonomous activation of the feature based on the timer comprises autonomously activating the feature upon discarding a packet upon expiry of the PDCP timer.

22. The method of claim 21 wherein a PDCP packet duplication leg is a Radio Link Control, RLC, entity to which PDCP duplication is activated.

23. The method of claim 21 wherein the one or more parameters comprise information that identifies one or more PDCP packet duplication legs to be prioritized by the wireless communication device for autonomous PDCP activation or autonomous activation of one or more additional PDCP packet duplication legs.

24. The method of claim 21 wherein the one or more parameters comprise information that indicates a number of PDCP packet duplication legs that can be activated by the wireless communication device for autonomous PDCP activation or autonomous activation of one or more additional PDCP packet duplication legs.

25. A base station adapted to:
provide a timer related to survival time to a wireless communication device, the survival time being an amount of time that an application consuming a communication service may continue without an anticipated message; and
provide, to the wireless communication device, one or more parameters related to autonomous activation of a feature at the wireless communication device, the feature being Packet Detection Convergence Protocol, PDCP, packet duplication, one or more additional PDCP packet duplication legs in a case where PDCP packet duplication is already activated, or some other mechanism that increases reliability of packet transmission;
where the timer is a PDCP discard timer, and autonomous activation of the feature based on the timer comprises autonomously activating the feature upon discarding a packet upon expiry of the PDCP timer.

26. (canceled)

27. A base station comprising:
processing circuitry configured to cause the base station to:
provide a timer related to survival time to a wireless communication device, the survival time being an amount of time that an application consuming a communication service may continue without an anticipated message; and
provide, to the wireless communication device, one or more parameters related to autonomous activation of a feature at the wireless communication device, the feature being Packet Detection Convergence Protocol, PDCP, packet duplication, one or more additional PDCP packet duplication legs in a case where PDCP packet duplication is already activated, or some other mechanism that increases reliability of packet transmission;
where the timer is a PDCP discard timer, and autonomous activation of the feature based on the timer comprises autonomously activating the feature upon discarding a packet upon expiry of the PDCP timer.

28. (canceled)
